(19) United States
(12) Patent Application Publication
(10) Pub. No.: US 2007/0058086 A1
(43) Pub. Date: Mar. 15, 2007

(54) Color display device using bi-directional scanning method

(75) Inventors: In-Jae Yeo, Yongin-si (KR); Sang-Kyeong Yun, Suwon-si (KR); Kyu-Bum Han, Suwon-si (KR); Seung-Won Ryu, Suwon-si (KR)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Samsung Electro-Mechanics Co., Ltd., Suwon-si (KR)

(21) Appl. No.: 11/520,111

(22) Filed: Sep. 12, 2006

(30) Foreign Application Priority Data
Aug. 17, 2006 (KR) 10-2006-0077538
Sep. 12, 2005 (KR) 10-2005-0084588

(51) Int. Cl. H04N 5/66; H04N 9/12

(52) U.S. Cl. 348/739

(57) ABSTRACT

A bi-directional scan type color display device is disclosed, comprising: a light source part emitting color lights according to a light source control signal; an optical modulator element modulating the color lights according to an optical modulator control signal, thereby generating diffracted lights; a scanner bi-directionally scanning and then projecting the diffracted lights emitted from the optical modulator element according to a scanner control signal; and an image control circuit controlling the light source part, the optical modulator element and the scanner by transferring the light source control signal, the optical modulator control signal and the scanner control signal thereto in correspondence with image information which will be displayed on the screen.

### BACKGROUND

1. Technical Field

The present invention relates to a color display device, in particular, to a color display device outputting a two dimensional image by scanning a one dimensional image signal from a single optical modulator element, on a screen by employing a scanner.

2. Description of the Related Art

As display technologies have advanced, the demand on large screen display devices has grown. The majority of current large screen display devices (mainly projectors) are using liquid crystals as a light-switcher. Such a liquid crystal projector has been popular due to the fact that it is smaller, cheaper, and has a simpler optical system than a CRT projector. However, in the liquid crystal projector, a large amount of light is lost since the light is projected to a screen by passing through a liquid crystal panel. A micro-machine such as an optical modulator element using reflection is employed to reduce such light loss, by which brighter images are obtained. The micro-machine refers to a miniature machine indiscernible with naked eyes. It can also be called a micro electro mechanical system (MEMS), and mainly fabricated by semiconductor manufacturing technology. These micro-machines are applied in information devices such as a magnetic and optical head by using micro-optics and limitation elements, and also applied in the bio-medical field and the semiconductor manufacturing process by using various micro-fluidics. The micro-machines can be divided based on their function into a micro-sensor, a micro-actuator and a miniature machine.

The MEMS can also be applied in optics. Using MEMS technology, optical components smaller than 1 mm can be fabricated, by which micro optical systems are implemented.

Micro optical components belonging to the micro-miniature optical system such as an optical modulator element, a micro-lens, and the like are applied in telecommunication devices, display devices and recording devices, due to such advantages as quick response time, low level of loss, and convenience in layering and digitalizing.

FIG. 1 shows a conventional three panel type color display device, each using an optical modulator element in which a MEMS element is applied.

The conventional three-panel type color display device comprises a light source part 110, an illumination part 120, three panels 130, a color synthesizing part 150, a projection system 160 and a screen 170.

The light source part 110 consists of a plurality of laser light sources, each consisting of a red light source 112, a green light source 114, and a blue light source 116, which are the three primary colors of light. Each color light from the light source part 110 is incident via beam forming lenses 120a and 120b of the illumination part 120 to each panel 130.

The three panels 130 each have an optical modulator element 132, 134, 136, each of which deals with each of the color lights. The optical modulator elements 132, 134 and 136 modulate the intensity of the incident color lights (red, green, and blue lights), and the modulated lights are later projected to the color synthesizing part 150.

A color-synthesizing filter 152 in the color synthesizing part 150 combines the intensity-modulated red, green, and blue lights, from the synthesized product of which only signal components are extracted by a space filter 154.

The signal components are scanned to the space by a scanner 162 (FIG. 1 shows a galvano mirror as an example) of the projection system 160 synchronizing with image signals, and projected on the screen 170 as a color image by projection lens 164.

The aforementioned conventional three-panel type color display device should have three optical modulator elements corresponding to the three laser light sources, causing the optical system to be complicated and the manufacturing cost to increase. Furthermore, in the case that the optical power of one of the laser light sources is weak, image quality deteriorates.

### SUMMARY

Accordingly, the present invention aims to provide a single panel type color display device that can simplify its optical system and circuit pattern and thus reduces the overall material cost considerably by reducing the number of panels by two compared to a three panel type color display device by employing a single panel using a single optical modulator element.

Also, the present invention aims to provide a single panel type color display device using a bi-directional scanning method, due to which the scanning frequency of a scanner reduces by half compared to one using a unidirectional scanning method, so that a manufacturing specification can be simplified and the life span of the scanner can be lengthened.

One aspect of the present invention provides a bi-directional scan type color display device, comprising: a light source part emitting color lights according to a light source control signal; an optical modulator element modulating the color lights according to an optical modulator control signal, thereby generating diffracted lights; a scanner bi-directionally scanning and then projecting the diffracted lights emitted from the optical modulator element according to a scanner control signal; and an image control circuit controlling the light source part, the optical modulator element and the scanner by transferring the light source control signal, the optical modulator control signal and the scanner control signal thereto in correspondence with image information which will be displayed on the screen.

Here, the diffracted light is projected onto the screen to express one vertical line image, which is a one dimensional image, and displayed as a two dimensional image by employing the scanner bi-directionally scanning in a horizontal direction.

Further, the diffracted light is projected onto the screen to express one horizontal line image, which is a one dimensional image, and displayed as a two dimensional image by employing the scanner bi-directionally scanning in a vertical direction.

Further, the light source part comprises red, green, and blue light sources, of which on/off states are controlled according to the light source control signal.

Here, in the case that one of the red, green, and blue light sources is turned on, the other light sources are turned off.

Also, the image information contains information regarding the intensity of red, green, and blue lights with respect to pixels constituting one frame, of which number is equal to (the number of vertical line pixels)×(the number of horizontal line pixels)

Here, the image control circuit transfers the light-intensity information corresponding to a color of the turned on light source to the optical modulator element, in synchronization with the optical modulator control signal.

Here, the scanner projects the diffracted light corresponding to one of red, green, and blue colors forming one frame to the screen, with each half rotation.

Also, the scanner projects the diffracted lights respectively corresponding to red, green, and blue colors onto the screen through one and a half rotations, one diffracted light per half rotation.

Further, the scanner performs one rotation within 1/(1.5×the field frequency according a television broadcasting system) [sec].

Also, the scanner comprises a galvano mirror.

Additional aspects and advantages of the present general inventive concept will be set forth in part in the description which follows, and in part will be obvious from the description, or may be learned by practice of the general inventive concept.

### DESCRIPTION OF THE DRAWINGS

These and other features, aspects, and advantages of the present invention will become better understood with regard to the following description, appended claims, and accompanying drawings where:

FIG. 1 shows an embodiment of a conventional color display device having three panels, each using an optical modulator element in which a MEMS element is applied;

FIGS. 2(a) and (b) illustrate the configuration of a GLV (grating light valve) device, one of the optical modulators manufactured by the Silicon Light Machine Co., Ltd.;

FIGS. 3(a) and (b) show a principle by which incident lights are modulated in the GLV device of FIG. 2;

FIG. 4A is a perspective view of a diffraction type optical modulator element using piezoelectric elements, one of indirect type optical modulators applicable to an embodiment of the present invention;

FIG. 4B is a perspective view of another diffraction type optical modulators element using piezoelectric elements applicable to an embodiment of the present invention;

FIG. 4C is a plan view of a diffraction type optical modulator array applicable to an embodiment of the present invention;

FIGS. 4D(a) and (b) explain the principle of optical modulation in a diffraction type optical modulator applicable to an embodiment of the present invention;

FIG. 5 is a diagram showing an image generated on a screen by a diffraction type optical modulator array applicable to an embodiment of the present invention;

FIG. 6 illustrates a schematic configuration of a bi-directional scanning type color display device having a single panel according to an embodiment of the present invention;

FIGS. 7(a) and (b) show the configuration of a frame projected on a screen according to the present invention;

FIGS. 8(a), (b), (c), and (d) show how a color image is displayed according to an embodiment of the present invention;

FIG. 9 shows how color images are displayed consecutively according to an embodiment of the present invention; and

FIG. 10 shows an example in which an image control circuit transfers light source control signals, optical modulator control signals and scanner control signals according to an embodiment of the present invention.

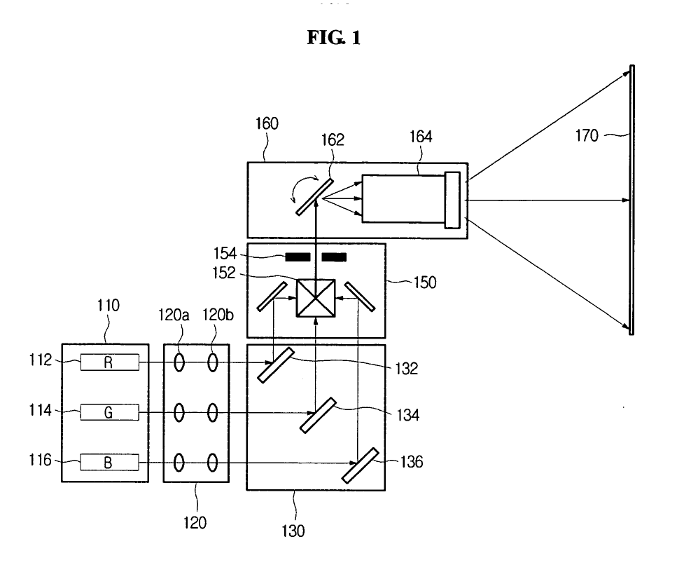

### DETAILED DESCRIPTION

Hereinafter, embodiments of the invention will be described in more detail with reference to the accompanying drawings. In the description with reference to the accompanying drawings, those components are rendered the same reference number that are the same or are in correspondence regardless of the figure number, and redundant explanations are omitted.

An optical modulator applicable to the present invention will first be described before discussing embodiments of the present invention.

The optical modulator can be divided mainly into a direct type, which directly controls the on/off state of light, and an indirect type, which uses reflection and diffraction. The indirect type may be further divided into an electrostatic type and a piezoelectric type. Optical modulators are applicable to the embodiments of the present invention regardless of the operation type.

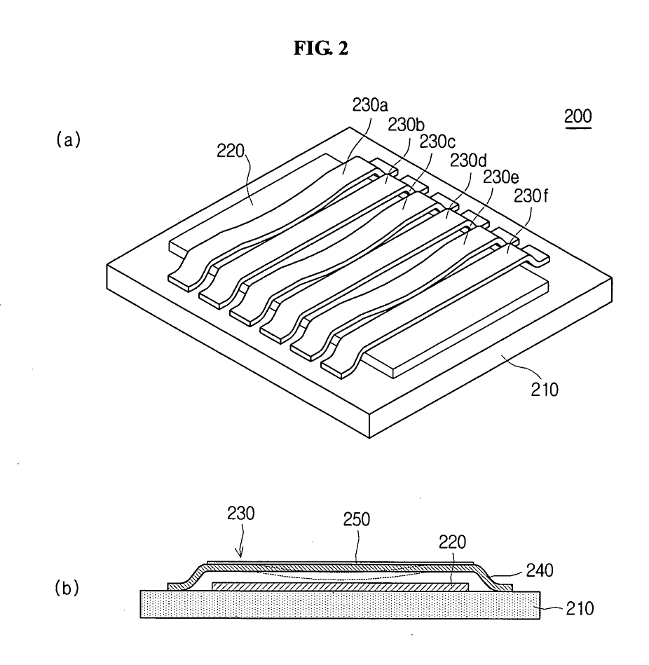

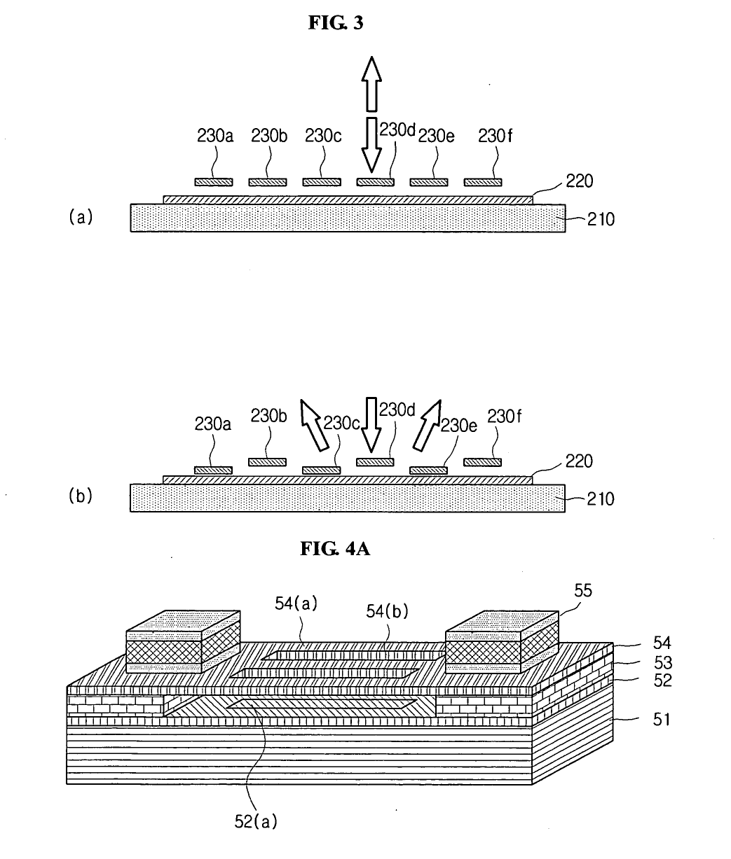

FIGS. 2(a) and (b) show the configuration of GLV (grating light valve) device, one of the light modulators manufactured by the Silicon Light Machine Co., Ltd, and FIGS. 3(a) and (b) show a principle by which an incident light is modulated in the GLV device 30 of the FIGS. 2(a) and (b).

As shown in FIGS. 2(a) and (b), the GLV device 200 comprises an insulation substrate 210 such as a glass substrate, a substrate side electrode 220 formed on the insulation substrate 210, and a plurality of beams 230a to 230f, hereinafter abbreviated as 230 (here in this embodiment, the number of the beams is 6), having a bridge-shape and disposed across the substrate side electrode 220 in parallel.

Each beam 230 comprises a bridge part 240 and a drive side electrode 250 formed of an aluminum (Al) film and mounted on the bridge part 240 to function also as a reflective film, so that both ends of the beam 230 are supported to form a so called bridge type.

The beam 230 gets bent due to attractive or repulsive forces between itself and the substrate side electrode 220 according to electric potential between the substrate side electrode 220 and the drive side electrode 250. As drawn in solid and dotted lines of FIG. 2(b), the beam 230 bends toward the substrate side electrode 220 or returns to a parallel mode.

The plurality of beams 230 are alternatively changed to the parallel or concave mode. In the case that the beams 230 are not supplied with power, the beams 230 remain in the parallel mode as shown in FIG. 3(a). When a minute power is supplied to the odd-numbered beams 230a, 230c, and 230e, the odd-numbered beams 230a, 230c, and 230e are converted to the concave mode, while the even-numbered beams 230b, 230d, and 230f remain in the parallel mode. In such case, incident light is diffracted (interfered) due to the path difference between a first reflective light reflected by the odd-numbered beams 230a, 230c, and 230e and a second reflective light reflected by the even-numbered beams 230b, 230d, and 230f, so that the intensity of the light is modulated. By using the above, the gray scale of screen pixels, namely light intensity, is expressed. It is assumed that the plurality of beams 230 (the number of them is six in this embodiment) express a single light intensity, and constitute a single micro-mirror.

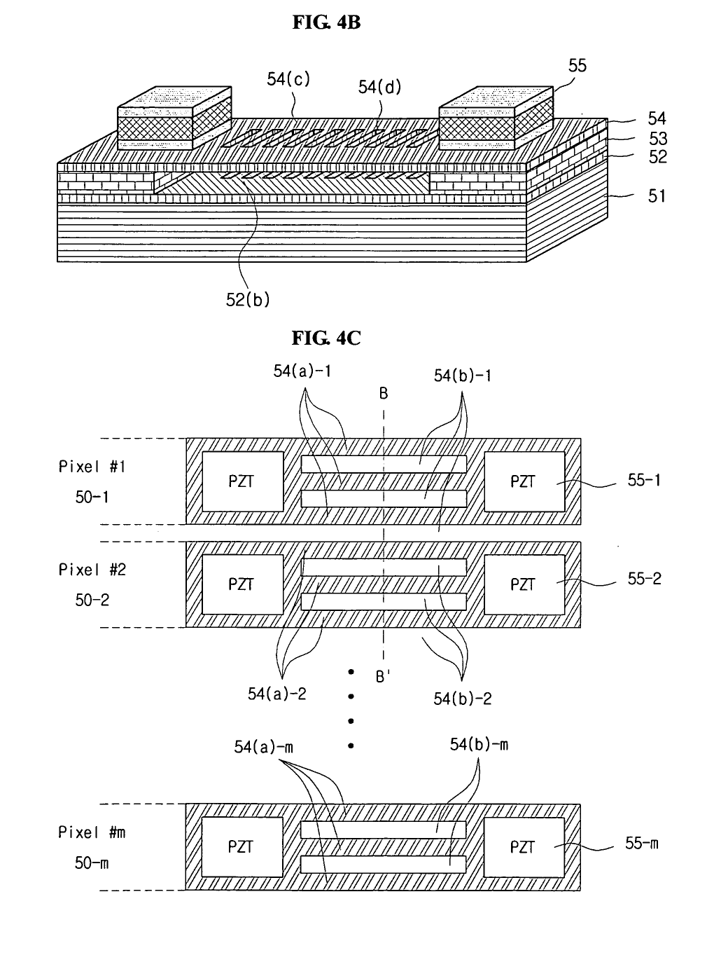

FIG. 4A is a perspective view of a diffraction type optical modulator element using piezoelectric elements, one of indirect type optical modulators applicable to the embodiments of the present invention, and FIG. 4B is a perspective view of another diffraction type optical modulator element using piezoelectric elements applicable to the embodiments of the present invention. In FIGS. 4A and 4B is illustrated an optical modulator comprising a substrate 51, an insulation layer 52, a sacrificial layer 53, a ribbon structure 54 and piezoelectric elements 55.

The substrate 51 is a commonly used semiconductor substrate, and the insulation layer 52 is deposited as an etch stop layer. The insulation layer 52 is formed of a material with a high selectivity to the etchant (the etchant is an etchant gas or an etchant solution) that etches the material used as the sacrificial layer. Here, reflective layers 52(a) and 52(b) may be formed on the insulation layer 52 to reflect incident light.

The sacrificial layer 53 upholds the ribbon structure 54 at both ends of the ribbon structure 54 to leave a gap between the ribbon structure 54 and the insulation layer 52, and forms a space in the center part.

As described above, the ribbon structure 54 modulates signals optically by creating diffraction and interference in the incident light. The ribbon structure 54 may be composed of a plurality of ribbon shapes according to the electrostatic type, and may have a plurality of open holes in the center part of the ribbons according to the piezoelectric type. The piezoelectric elements 55 control the ribbon structure 54 to move vertically according to the degree of up/down or left/right contraction or expansion generated by the voltage difference between the upper and lower electrodes. Here, the reflective layers 52(a) and 52(b) are formed in correspondence with holes 54(b) and 54(d) formed on the ribbon structure 54.

The descriptions below will focus on the type of optical modulator illustrated in FIG. 4A.

As shown in FIG. 4C, the optical modulator has an m number of micro-mirrors 50-1, 50-2, . . . , and 50-m, respectively responsible for pixel #1, pixel #2, . . . , and pixel #m. The optical modulator deals with image information with respect to one-dimensional images of vertical or horizontal scanning lines (here, it is assumed that a vertical or horizontal scanning line consists of an m number of pixels), and each micro-mirror 50-1, 50-2, . . . , 50-m deals with each of the m pixels constituting the vertical or horizontal scanning lines. Accordingly, the light beam reflected and diffracted by each micro-mirror is later projected by an optical scanning device on a screen as a two dimensional image. For instance, in the case of VGA 640*480 resolution, 480 vertical pixels are modulated 640 times on one surface of the optical scanning device (not shown in the accompanying drawings) so as to generate one frame per surface of the optical scanning device. Here, the optical scanning device may be a polygon mirror, a rotating bar, or a galvano mirror.

Below here, the principle of optical modulation will be set forth with an emphasis on the pixel #1, however, the following description can surely be applied to the other pixels in the same way.

In the present embodiment, it is assumed that two holes 54(b)-1 are formed in the ribbon structure 54. Due to the two holes 54(b)-1, there are three upper reflective layers 54(a)-1 formed on an upper part of the ribbon structure 54. On the insulation layer 52 are formed two lower reflective layers in correspondence with the two holes 54(b)-1. Besides, another lower reflective layer is formed on the insulation layer 52 in correspondence with a gap between the pixel #1 and the pixel #2. Consequently, the number of the upper reflective layers 54(a)-1 per pixel is the same as the number of the lower reflective layers, and the brightness of the modulated light can be controlled by using the modulated light (0th order diffracted light or 35 1st order diffracted lights).

FIGS. 4D(a) and (b) are cross-sectional views along the line BB′ of FIG. 4C, explains a principle of the optical modulation in a diffraction type optical modulator.

For example, in the case where the wavelength of the light equals λ, a first voltage is applied to the piezoelectric elements 55 so that the gap between the upper reflective layer 54(a), 54(c) formed on the ribbon structure 54 and the insulation layer 52, where the lower reflective layer 52(a), 52(b) is formed, becomes equal to (2n)λ/4 (wherein n is a natural number). Accordingly, in the case of a zeroth (0th) order diffracted light (reflected light) beam, the overall path difference between the light reflected from the upper reflective layer 54(a), 54(c) formed on the ribbon structure 54 and the light reflected from the insulation layer 52 is equal to nλ, so that the modulated light has a maximum brightness due to a constructive interference. On the other hand, in the case of +b 1st and −1st order diffracted lights, the brightness is at its minimum level due to a destructive interference.

A second voltage is applied to the piezoelectric elements 55 so that the gap between the upper reflective layer 54(a), 54(c) formed on the ribbon structure 54 and the insulation layer 52, where the lower reflective layer 52(a), 52(b) is formed, becomes equal to (2n+1)λ/4 (wherein n is a natural number). Accordingly, in the case of 0th-order diffracted light (reflected light) beam, the overall path difference between the light reflected from the upper reflective layer 54(a), 54(c) formed on the ribbon structure 54 and the light reflected from the insulation layer 52 equals to (2n+1)λ/2, so that the modulated light has its minimum brightness due to a destructive interference. However, in the case of +1st and −1st order diffracted light, the brightness is at its maximum level due to a constructive interference. As a result of such interference, the optical modulator can load signals on the light beam by regulating the quantity of the reflected or diffracted light.

Although the foregoing describes the cases in which the gap between the ribbon structure 54 and the insulation layer 52 on which the lower reflective layer 52(a), 52(b) is formed is equal to (2n)λ/4 or (2n+1)λ/4, it is obvious that a variety of embodiments, having a gap with which the intensity of light is controlled by diffraction and reflection, can be applied to the present invention.

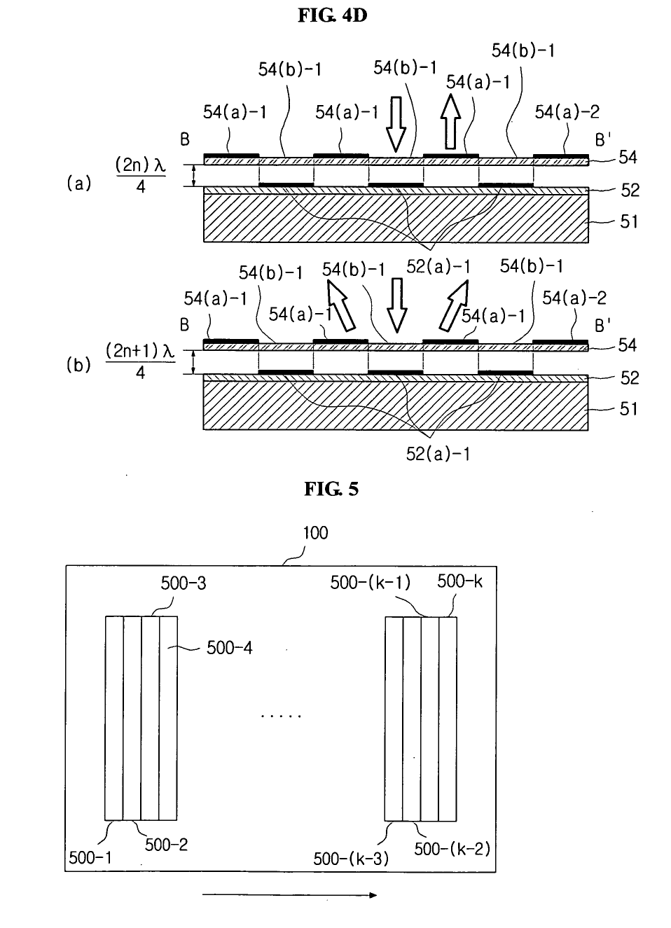

FIG. 5 shows an image generated by a diffraction type optical modulator array applicable to embodiments of the present invention.

The light reflected and diffracted by an m number of vertically arranged micro-mirrors 50-1, 50-2, . . . , and 50-m is reflected from the optical scanning device, and then scanned horizontally on a screen 100, thereby generating pictures 500-1, 500-2, 500-3, 500-4, . . . , 500-(k-3), 500-(k-2), 500-(k-1), and 500-k. One image frame may be projected with one rotation of the optical scanning device. Although the scanning starts from the left to the right (the direction of the arrow), the scanning may also be performed in the opposite direction.

In the present invention, the optical modulator element generates diffracted lights of diverse intensities by employing a GLV device, a MEMS structure, or the interference principle, thereby capable of loading a variety of signals on the light. The optical modulator collectively refers to a device dealing with one dimensional image pixels as described above.

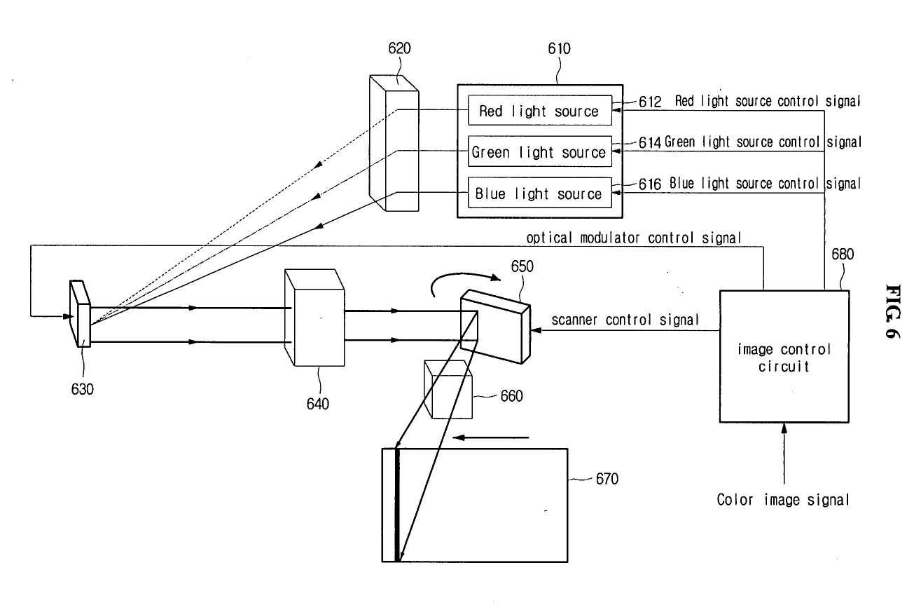

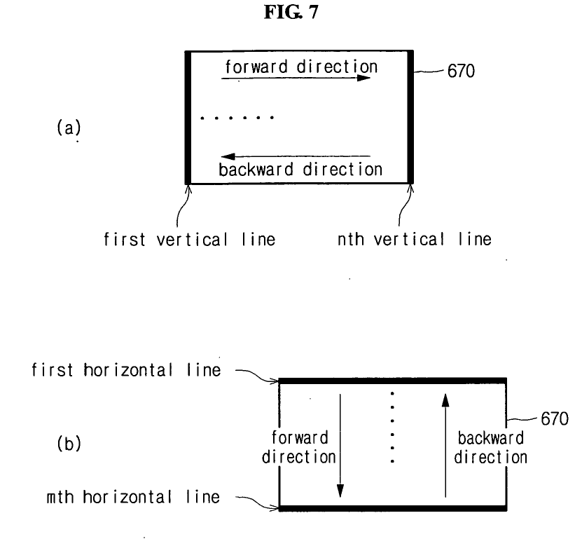

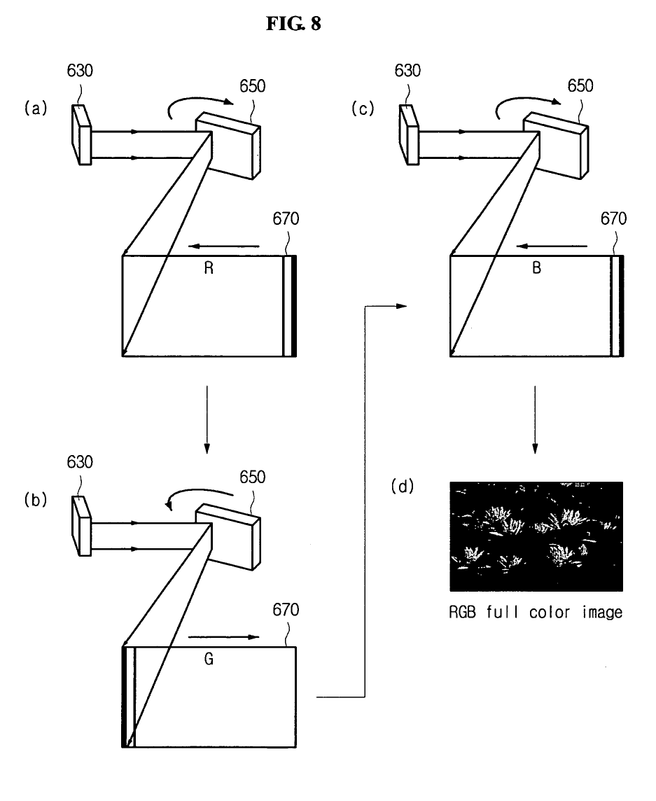

FIG. 6 shows a schematic configuration of a bi-directional scanning type color display device having a single panel according to an embodiment of the present invention. In the present invention, the color display device typically refers to a projection device. FIG. 7 illustrates the configuration of a frame projected on the screen according to the present invention, and FIG. 8 shows how a color image is displayed according to an embodiment of the present invention.

Referring to FIG. 6, the bi-directional scanning type color display device having a single panel comprises a light source part 610, an optical illumination part 620, a single panel (namely, a single optical modulator element 630), an optical relay part 640, a scanner 650, an optical projection part 660, a screen 670 and an image control circuit 680. Here, descriptions on the optical illumination part 620, the optical relay part 640 and the optical projection part 660 will be omitted as they are components commonly used in the projection device.

The light source part 610 comprises a red light source 612, a green light source 614 and a blue light source 616 emitting red, green, and blue lights respectively. The red, green, and blue light sources 612, 614, and 616 are preferably laser light sources or laser diodes.

Each color light from the light source part 610 is incident on the single panel (namely, the optical modulator element 630) through the optical illumination part 620.

The optical modulator element 630 receives one color light at one time from the red, green, or blue light sources 612, 614 or 616. Two or more color lights are not incident at the same time, but preferably one color light at one time.

As described above, the optical modulator element 630 generates diffracted lights by modulating the incident lights according to information regarding the intensity of the lights with respect to one line. Here, the one line refers to one of the horizontal or vertical line among pixels, the number of which is equal to (the number of lateral pixels (namely, the number of horizontal line pixels))×(the number of longitudinal pixels (namely, the number of vertical line pixels)), constituting one frame. Although the description below will focus on the case in which the optical modulator element 630 deals with one of the vertical lines, this shall not limit the scope of the present invention.

The optical modulator element 630 preferably has as many GLV devices shown in FIG. 2 or MEMS structures shown in FIGS. 4A-4D as the number of pixels of one line aligned with each other in parallel so as to deal with the one vertical line. The one vertical line is a one dimensional image, which is expressed as a two dimensional image by the scanner 650 to be displayed on the screen 670 as a two dimensional image.

The optical modulator element 630 receives a color light including no image information, and loads image information (namely, information regarding the intensity of the lights) of corresponding color light and corresponding line on the color light according to an optical modulator control signal received from the image control circuit 680, which will be described later. The foregoing process is called a color light modulation. The optical modulator element 630 is responsible for the function of a panel expressing the image information. Through this, the color light having the image information, namely, a diffracted light, is transferred to the scanner 650 via the optical relay part 640.

The scanner 650 scans the diffracted light to the space according to a scanner control signal from the image control circuit 680. The optical projection part 660 comprises a projection lens, and projects the diffracted light scanned to the space by the scanner 650 on the screen 670 as a color image

As described above, the diffracted light scanned to the space by the scanner 650 is a one dimensional image signal, which was modulated by the optical modulator element 630, and thereby represents one of the vertical lines constituting a frame of pictures.

The scanner 650 bi-directionally rotates in a horizontal direction, by which the diffracted light is projected to a vertical line positioned in correspondence with an image signal on the screen 670. After all the image signals corresponding to each vertical line are projected in a horizontal direction due to the rotation of the scanner 650, one frame, namely, one picture is completed.

The scanner 650 of the present invention can be any device capable of rotating bi-directionally and therefore capable of representing a one dimensional image as a two dimensional image, like a galvano mirror.

The image control circuit 680 accommodates image information regarding the frames constituting one picture. The image information contains information regarding the intensity of red, green, and blue lights of pixels of which number is equal to (the number of vertical line pixels)×(the number of horizontal line pixels). For example, in the case that the number of vertical line pixels is m (m is a natural number), and the number of horizontal line pixels is n (n is a natural number), one frame is said to consist of an n number of vertical lines or an m number of horizontal lines. (See FIGS. 7(a) and (b)).

The image control circuit 680 extracts the information regarding the intensity of red, green, and blue lights according to a predetermined order. For example, the extraction may be performed in the order of red, green, and blue colors, and the order can be changed.

Referring to FIGS. 7(a) and (b), in the case that the scanner 650 scans in a horizontal direction, a direction from a first vertical line to an nth vertical line is defined as a forward direction, and a direction from the nth to the first is defined as a backward direction.

In the case that the scanner 650 scans in a vertical direction, a direction from a first horizontal line to an mth horizontal line is defined as a forward direction, and a direction from the mth to the first is defined as a backward direction.

In FIGS. 8(a)-(d), the scanning is performed by the scanner 650 in a horizontal direction, and the optical modulator element 630 modulates an n number of vertical lines one by one. However, the scanning can be performed in a vertical direction, and also the optical modulator element 630 can modulate an m number of horizontal lines one by one.

Referring to FIG. 8(a), in the case that the information regarding red color is first extracted, a light source control signal is delivered to the light source part 610 so that the red light source 612 is turned on, but the green light source 614 and the blue light source 616 are turned off. Also, the information regarding the intensity of red color light with respect to the n number of vertical lines, namely, an optical modulator control signal is delivered to the optical modulator element 630.

At the time a diffracted light modulated by the optical modulator element 630 according to the optical modulator control signal is transferred to the scanner 650, a scanner control signal is also delivered, according to which the scanner 650 rotates to adjust its direction so that the diffracted light can be projected to a location on the screen 670 corresponding to the nth vertical line. After this, the optical modulator control signals and the scanner control signals respectively corresponding to from (n−1)th to first vertical lines, are sequentially delivered to the optical modulator element 630 and the scanner 650. Here, the scanner control signal may be an angular speed control signal, according to which the scanner 650 rotates in a first direction (clockwise, in this example) at a predetermined rate, or may be a position control signal according to which the scanner 650 rotates to a predetermined position at a certain time.

Referring to FIG. 8(b), after the backward directional projection on the n number of vertical lines of the screen 670 is completed, the image control circuit 680 extracts the information regarding green color light. Next, the green color information is projected in a similar manner as the red color information. However, because the scanner 650 scans bi-directionally, in the case of green color, the projection is performed in a forward direction, from the first vertical line to the nth vertical line. Accordingly, when the green color information is extracted, the optical modulator control signal, corresponding to the information regarding the light intensity with respect to the first vertical line, should be first delivered to the optical modulator element 630. The scanner control signal delivered to the scanner 650 likewise may be an angular speed control signal according to which the scanner 650 rotates in a second direction at a predetermined direction (counter-clockwise, in this example) or a position control signal, according to which the scanner 650 rotates to a predetermined position.

Referring to FIG. 8(c), after the forward directional projection on the n number of vertical lines of the screen 670 is completed, the image control circuit 680 extracts the information regarding the intensity of blue color light in the end. Then, the blue color information is projected in the same manner as the red color information.

Referring to FIG. 8(d), through finishing the projection of red, green, and blue color lights, one picture with a full color image can be completed, for which it should take less than 1/(the field frequency according to a television broadcasting system) [sec].

The field frequency according to a television broadcasting system refers to a minimum frequency at which a video stream is perceived by human eyes without an image interruption. Television broadcasting systems for a color display device are mainly divided into NTSC (national television system committee) system and PAL (phase alternation by line) system.

In the NTSC system, red, green, and blue signals are matrix transformed to one luminance signal (Y) and two chrominance signals (I, Q), and then transmitted with a bandwidth of 6 MHz. The PAL system improved the drawback of the NTSC in the color transmission.

While the NTSC has 525 scanning lines and a 60 Hz of field frequency, PAL has 625 scanning lines and a 50 Hz of field frequency.

When the primary colors are projected to one picture within a time less than 1/(field frequency (in the case of NTSC, 60 Hz, and in the case of PAL, 50 Hz))[sec], human eyes have an illusion that a picture having a full color image is being formed simultaneously. Accordingly, in the case that red, green, and blue colors are projected each once within a time less than 1/(field frequency)[sec], humans feel as if the three colors are simultaneously projected.

To obtain the foregoing effect, the scanner 650, capable of a bi-directional scanning, may project red, green, and blue colors through one and a half rotations, namely, one color per half rotation. During one rotation of the scanner 650, the forward and backward directional projections are performed. Consequently, the one and a half rotations of the scanner 650 preferably takes less than 1/(the field frequency) [sec], and a bi-directional scan frequency of the scanner 650 preferably is 1.5 times as high as the field frequency.

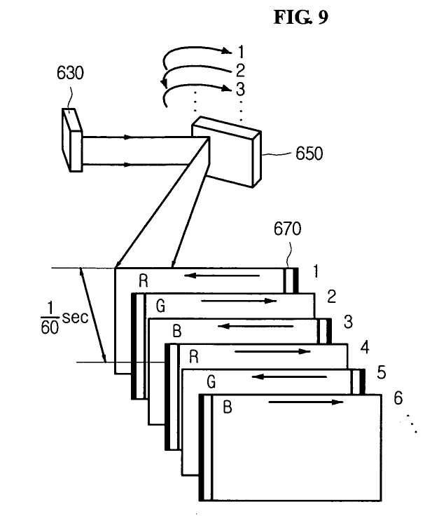

FIG. 9 shows how color images are displayed consecutively in accordance with an embodiment of the present invention Referring to FIG. 9, during a first step, with the scanner 650 rotating in a clockwise direction and the red light source 612 being solely turned on, only the red color information among the image information of a kth (k is an arbitrary natural number) frame is modulated by the optical modulator element 630 before projected to the screen 670 in the backward direction.

During a second step, with the scanner 650 rotating in a counter-clockwise direction and the green light source 614 being solely turned on, only the green color information among the image information of a kth (k is an arbitrary natural number) frame is modulated by the optical modulator element 630 before projected to the screen 670 in a forward direction.

During a third step, with the scanner rotating in the clockwise direction and the blue light source 616 being solely turned on, only the blue color information among the image information of a kth (k is an arbitrary natural number) frame is modulated by the optical modulator element 630 before projected to the screen 670 in the backward direction.

A full color image corresponding to the kth frame is generated through such first to third steps, which should be progressed within a time less than 1/60 [sec] in the case of NTSC system, and 1/50 [sec] in the case of PAL system.

During a fourth step, with the scanner 650 rotating in the counter-clockwise direction and the red light source 612 being solely turned on, only the red color information among the image information of a (k+1)th frame is modulated by the optical modulator element 630 before projected to the screen 670 in the forward direction.

During a fifth step, with the scanner 650 rotating in the clockwise direction and the green light source 612 being solely turned on, only the green color information among the image information of a (k+1)th frame is modulated by the optical modulator element 630 before projected to the screen 670 in the backward direction.

During a sixth step, with the scanner 650 rotating in the counter-clockwise direction and the blue light source 612 being solely turned on, only the blue color information among the image information of a (k+1)th frame is modulated by the optical modulator element 630 before projected to the screen 670 in the forward direction.

A full color image corresponding to the (k+1)th frame is generated through such fourth to sixth steps, which should be progressed within a time less than 1/60 [sec] in the case of NTSC system, and 1/50 [sec] in the case of PAL system.

By repeating the above first through sixth steps, full color images corresponding to (K+2)th, (K+3)th, . . . frames can be consecutively generated.

Here, it is obvious that the foregoing steps can be progressed in another order different from the order described above.

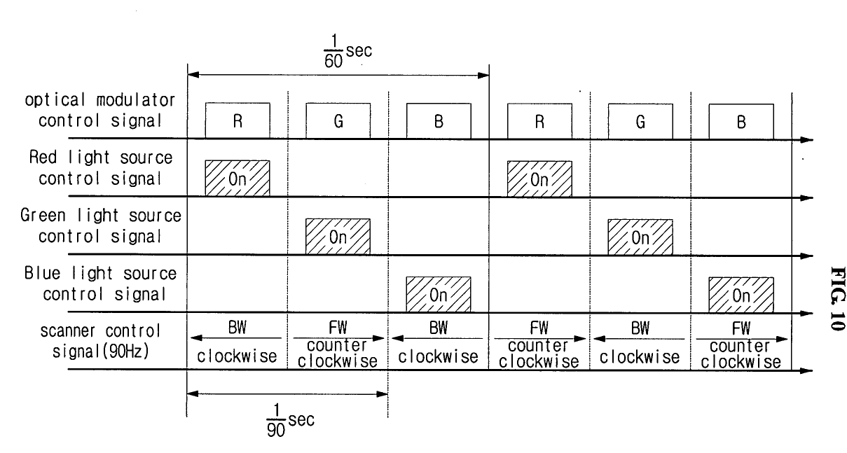

FIG. 10 shows an example in which the image control circuit 680 transfers light source control signals, optical modulator control signals and scanner control signals with the passage of time in accordance with an embodiment of the present invention. Although in FIG. 10, the light source control signals are inputted in the order of red, green, and blue, different order can surely be applied in the present invention. In this embodiment, the field frequency is 60 Hz based on NTSC system, and one frame has a period of 1/60 [sec].

Referring to FIG. 10, the optical modulator control signal comprising image information, namely, light-intensity information, is sent to the optical modulator element 630 in the order of red, green, and blue from the image control circuit 680

Such light source control signal is transferred from the image control circuit 680 to the light source part 610 that when red color information is delivered, only the red light source 612 is turned on, when green color information is delivered, only the green light source 614 is turned on, and when blue color information is delivered, only the blue light source 616 is turned on.

The image information is projected once per each color onto the screen 670 by the scanner 650, which scans in a backward direction with a clockwise rotation, and also in a forward direction with a counterclockwise rotation. The scanning can surely be performed in an opposite manner.

The scanner 650 performs one rotation by rotating in a clockwise direction once and in a counterclockwise direction once. Accordingly, red, green, and blue colors can be each once projected by one and a half rotations, thereby completing a full color image. It takes the scanner 650 1/90 [sec] to perform one rotation, and therefore the scan frequency is 90 Hz.

While the invention has been described with reference to the disclosed embodiments, it is to be appreciated that those skilled in the art can change or modify the embodiments without departing from the scope and spirit of the invention or its equivalents as stated below in the claims.

The embodiments of the invention in which an exclusive property or privilege is claimed are defined as follows:

1. A bi-directional scan type color display device comprising:
a light source part emitting color lights according to a light source control signal;
an optical modulator element modulating the color lights according to an optical modulator control signal, thereby generating diffracted lights;
a scanner bi-directionally scanning and then projecting the diffracted lights emitted from the optical modulator element according to a scanner control signal; and
an image control circuit controlling the light source part, the optical modulator element and the scanner by transferring the light source control signal, the optical modulator control signal and the scanner control signal thereto in correspondence with image information which is displayable on a screen.

2. The bi-directional scan type color display device of claim 1, wherein the diffracted light is projectable onto a screen to express a single line image, which is a one dimensional image, and displayable as a two dimensional image by employing the scanner bi-directionally scanning in the direction perpendicular to the length of the line image.

3. The bi-directional scan type color display device of claim 2, wherein the diffracted light is projectable onto a screen to express one vertical line image, which is a one dimensional image, and displayable as a two dimensional image by employing the scanner bi-directionally scanning in a horizontal direction.

4. The bi-directional scan type color display device of claim 2, wherein the diffracted light is projectable onto a screen to express one horizontal line image, which is a one dimensional image, and displayable as a two dimensional image by employing the scanner bi-directionally scanning in a vertical direction.

5. The bidirectional scan type color display device of claim 1, wherein the light source part comprises red, green, and blue light sources, of which on/off states are controlled according to the light source control signal.

6. The bi-directional scan type color display device of claim 5, wherein in the case that one of the red, green, and blue light sources is turned on, the other light sources are turned off.

7. The bi-directional scan type color display device of claim 5, wherein the image information contains information regarding the intensity of red, green, and blue lights with respect to pixels constituting one frame, of which number is equal to (the number of vertical line pixels)×(the number of horizontal line pixels).

8. The bi-directional scan type color display device of claim 7, wherein the image control circuit transfers the light-intensity information corresponding to a color of the turned on light source to the optical modulator element, in synchronization with the optical modulator control signal.

9. The bi-directional scan type color display device of claim 5, wherein the scanner projects the diffracted light corresponding to one of red, green, and blue colors forming one frame to the screen, with each half rotation.

10. The bi-directional scan type color display device of claim 9, wherein the scanner projects the diffracted lights respectively corresponding to red, green, and blue colors onto the screen through one and a half rotations, one diffracted light per half rotation.

11. The bi-directional scan type color display device of claim 9, wherein the scanner performs one rotation within 1/(1.5×the field frequency according a television broadcasting system) [sec].

12. The bi-directional scan type color display device of claim 1, wherein the scanner comprises a galvano mirror.
